(19) United States
(12) Patent Application Publication
(10) Pub. No.: US 2003/0192039 A1
(43) Pub. Date: Oct. 9, 2003

(54) Configuration management system & method

(76) Inventor: Richard G. McConnell, Harrison Township, MI (US)

Correspondence Address: HOGAN & HARTSON LLP, ONE TABOR CENTER, SUITE 1500, 1200 SEVENTEEN ST., DENVER, CO, 80202, US

(21) Appl. No.: 10/116,834

(22) Filed: Apr. 5, 2002

(51) Int. Cl. G09G 5/00; G06F 9/00; G06F 15/177

(52) U.S. Cl. 717/171; 345/741; 709/221

(57) ABSTRACT

A system and method for managing the configuration (e.g., patches and other configuration elements) of a plurality of computer-systems, such as servers and the like, is disclosed. The system can include, in some illustrative embodiments, a computer-system configuration monitoring utility that monitors the plurality of computer-systems, a database for storing computer-system configuration data received by the computer-system configuration monitoring utility, a check matrix engine that analyses the stored computer-system configuration data, and a report generating engine that generates configuration reports pertaining to a plurality of the plurality of computer-systems.

### FIELD OF THE INVENTION

The present invention relates generally to the management of computer-system configuration, including patch management and other system configuration management, for server computer systems, other computer systems and the like.

### INTRODUCTION

A computer system, such as a server, other computer or the like, can have a required set of patches to operate within acceptable limits. A patch can include, e.g., a repair job for a piece of programming. For example, during a software product's beta test distribution, try-out period and/or after a product is formally released, problems (e.g., bugs or the like) may occur. A patch can be a solution that is provided to users. For example, patches can sometimes be downloaded from a software maker's Web site. Patches are sometimes improved and/or updated. Product developers sometimes find better solutions that are released in later patches or provided when they package the product for its next release. In some instances, a patch is developed and distributed as a replacement for or an insertion in compiled code (such as, e.g., in a binary file or object module). A patch can include, e.g., an actual piece of object code that is inserted into (i.e., patched into) an executable program. In large operating systems, special programs are sometimes provided to manage and keep track of the installation of patches. Failure to update product patches can cause, e.g., reliability, availability and/or serviceability issues.

In some instances, patches can be retrieved from a Web page via a Web server or via an FTP server. In some instances, patch clusters (including, e.g., a plurality of patches) can be downloaded. In some instances, patch reports are provided that provide listings of all patches for a given operating system release. In some instances, the patch reports may contain links to each patch for easier download. In some cases, for example, patch reports may be distributed periodically (e.g., twice a month).

In addition to patch management, configuration management can broadly include, e.g., recording and/or updating information that describes computer systems and networks, including hardware and/or software components. This information can include, e.g., the versions and updates that have been applied to installed software packages and/or the locations and network addresses of hardware devices and more.

Configuration information can include, e.g., information regarding the way a system is set up and/or the assortment of components that make up the system. In some illustrative examples, a typical configuration for a personal computer (PC) can include information related to memory, floppy drives, magnetic disks, CD-ROM drives, modems, a video graphics array monitor and an operating system. In other illustrative examples, configuration can include information related to, e.g., software, hardware, memory, virtual memory, busses, disk drives, tape drives, disk access, small computer system interfaces (SCSI), redundant array of independent disks (RAID), file systems, I/O configuration and more. Configuration often encompasses, e.g., power configuration, platform configuration (such as, e.g., system controller configuration, storage configuration, etc.), memory and I/O configuration and the like.

In some instances, configuration management software is available. When a system requires a hardware and/or software upgrade, a manager can access the configuration management program and database to see what is currently installed.

In some instances, users may download patches, packages and the like to properly configure a system. A “package” can include, for example, a installable collection of files with embedded configuration details which instruct the installing program on file attributes, locations, pre and/or post installation procedures and/or on system requirements. Packages can be used to, for example, install operating systems, patches and/or to add and/or remove software.

With existing systems and processes, there are a variety of limitations. For example, system outages that are caused by improper configuration management can waste man-hours and money. Problems can be severe for customers with, for example, substantial numbers of servers or the like to manage. For example, customers may in some cases have, e.g., hundreds or thousands of servers to manage.

Existing utilities have been either single-system or single-product focused, with no global or wide-area management process involved. A single-system patch report is limited and does not provide a wide-based management strategy. Among other limitations, there is no way to:

manage system configuration such as, e.g., patch levels;

initiate standards for those configurations such as, e.g., patch levels; and

audit systems against a customer approved configuration baseline.

### SUMMARY OF THE PREFERRED EMBODIMENTS

Illustrative embodiments provide a system and method for configuration management, such as for example patch management, of a plurality of computer-systems.

In some illustrative embodiments, a system for managing configuration of a plurality of computer-systems includes: means for selecting an approved baseline configuration matrix to be applied to the plurality of computer-systems; means for retrieving computer-system configuration information from the plurality of computer-systems; means for comparing retrieved computer-system configuration information for the plurality of computer-systems to the approved baseline configuration matrix. In some embodiments, the system can further include means for generating reports regarding the configuration of a plurality of the plurality of computer-systems. In some embodiments, the system can further include a customer user administration interface means for at least one owner of configuration policy to add users and set user permissioning levels such that users may view the reports selectively based on user permissioning. In some embodiments, the reports include reports regarding the configuration of a plurality of systems within a plurality of data centers, within a specific data center, of an end user, of a project and/or within a particular environment.

In other illustrative embodiments, a method for managing configuration of a plurality of computer-systems can include: selecting an approved baseline configuration matrix to be applied to the plurality of computer-systems; retrieving computer-system configuration information from the plurality of computer-systems; comparing retrieved computer-system configuration information for the plurality of computer-systems to the approved baseline configuration matrix.

In other illustrative embodiments, a system for the global management of the configuration of a plurality of computer-systems can include: a computer-system configuration monitoring utility that monitors the plurality of computer-systems; a database for storing computer-system configuration data received by the computer-system configuration monitoring utility; a check matrix engine that analyses the stored computer-system configuration data; a report generating engine that generates configuration reports pertaining to a plurality of the plurality of computer-systems. In some embodiments, the computer-systems include a plurality of server computers. In some embodiments, the baseline configuration matrix includes a patch set matrix.

Various other embodiments, aspects, advantages and/or benefits of various embodiments of the present invention will be appreciated based on the present disclosure. It is contemplated that various embodiments will include and/or exclude different aspects, advantages and/or benefits and that descriptions of aspects, advantages and/or benefits of the various embodiments should not be construed as limiting other embodiments nor the inventions claimed.

### BRIEF DESCRIPTION OF THE DRAWINGS

The attached figures are shown by way of example and not limitation, in which:

FIG. 1A is a schematic diagram of an illustrative computer system according to some embodiments;

FIG. 1B is a schematic diagram of an illustrative computer system according to some embodiments;

FIG. 1C shows an illustrative system architecture that can be employed in some illustrative preferred embodiments;

FIG. 2 is a flow diagram of features and functionality available customer users upon log-in according to some embodiments;

FIG. 3 is a flow diagram of features and functionality available to company users upon log-in according to some embodiments;

FIG. 4 is a flow diagram of illustrative methods of matrix administration according to some embodiments;

FIG. 5 is a flow diagram showing illustrative customer user administration by individuals having corporate level permissioning and/or data center level permissioning according to some embodiments;

FIG. 6 is a flow diagram showing illustrative report generation for individuals having various levels of permissioning according to some embodiments;

FIG. 7 is an illustrative interface display that can be presented to certain users according to some illustrative embodiments;

FIG. 8 is another illustrative interface display showing a report of data center systems globally compared to an approved baseline that can be presented to certain users according to some illustrative embodiments;

FIG. 9 is another illustrative interface display showing a report of certain illustrative data center systems compared to an approved baseline that can be presented to certain users according to some illustrative embodiments;

FIG. 10 is another illustrative interface display showing a report of certain end user systems compared to an approved baseline that can be presented to certain users according to some illustrative embodiments;

FIG. 11 is another illustrative interface display showing a report of certain project systems compared to an approved baseline that can be presented to certain users according to some illustrative embodiments;

FIG. 12 is another illustrative interface display showing a report of certain project systems compared to an approved baseline that can be presented to certain users according to some illustrative embodiments; and

FIG. 13 is another illustrative interface display showing a report of certain environment system details compared to an approved baseline that can be presented to certain users according to some illustrative embodiments.

### DETAILED DESCRIPTION OF ILLUSTRATIVE EMBODIMENTS

In preferred embodiments, a configuration management system and process is provided. In illustrative embodiments, the system and process includes computer-company baseline matrices (such a company may include, e.g., a manufacturer, retailer or the like, such as, e.g., SUN MICROSYSTEMS® [“SUN”] as merely one illustrative example) and/or customer approved baseline matrices. These matrices include, e.g., approved patch sets. Preferably, the system and process enables the auditing of configuration and/or patch levels of individual systems or a plurality of systems within wide-area environments, such as, for example, entire data centers and/or global environments.

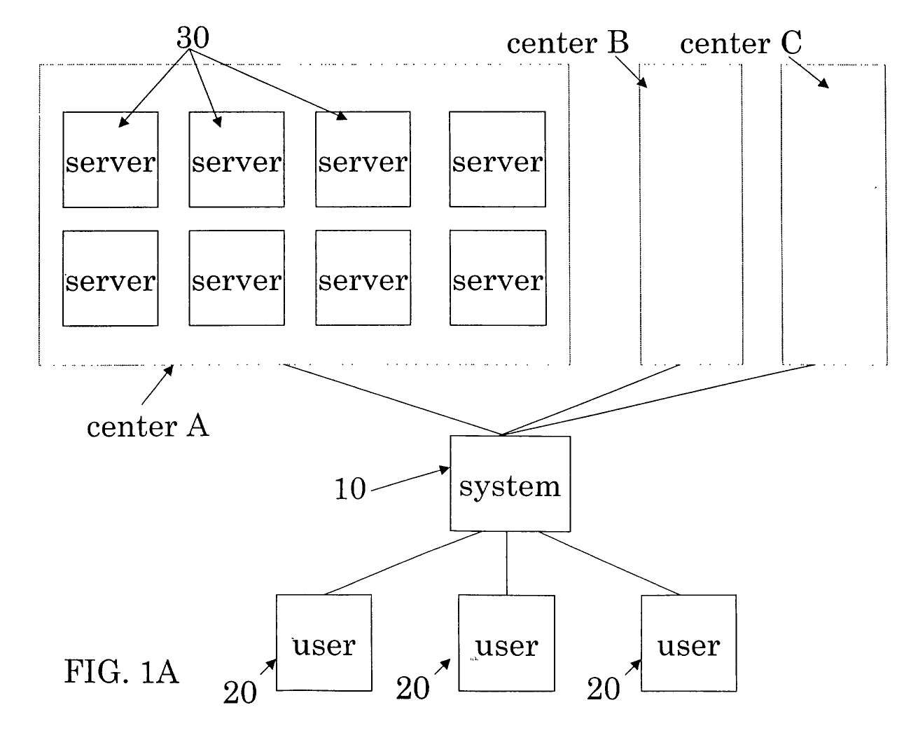

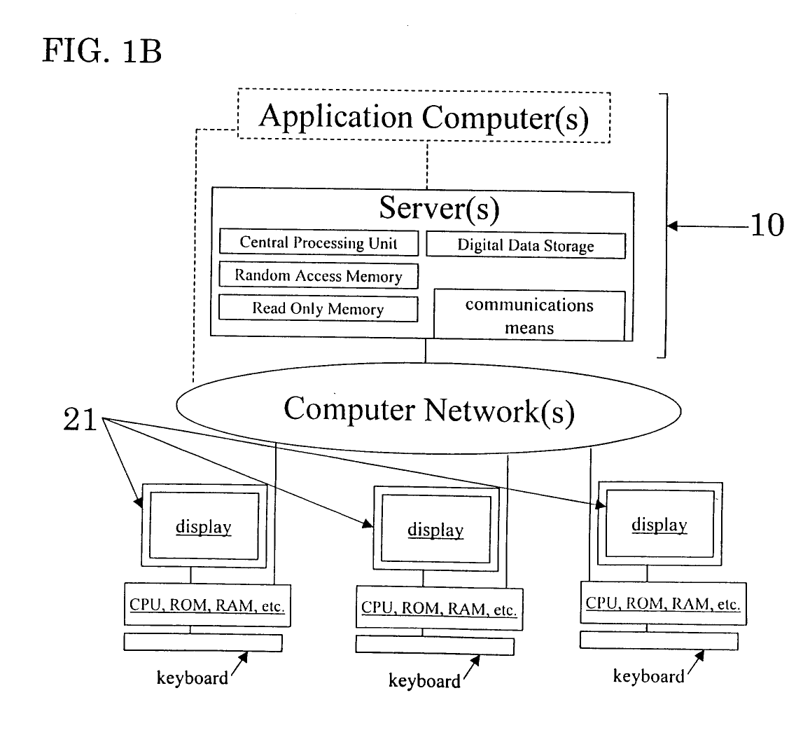

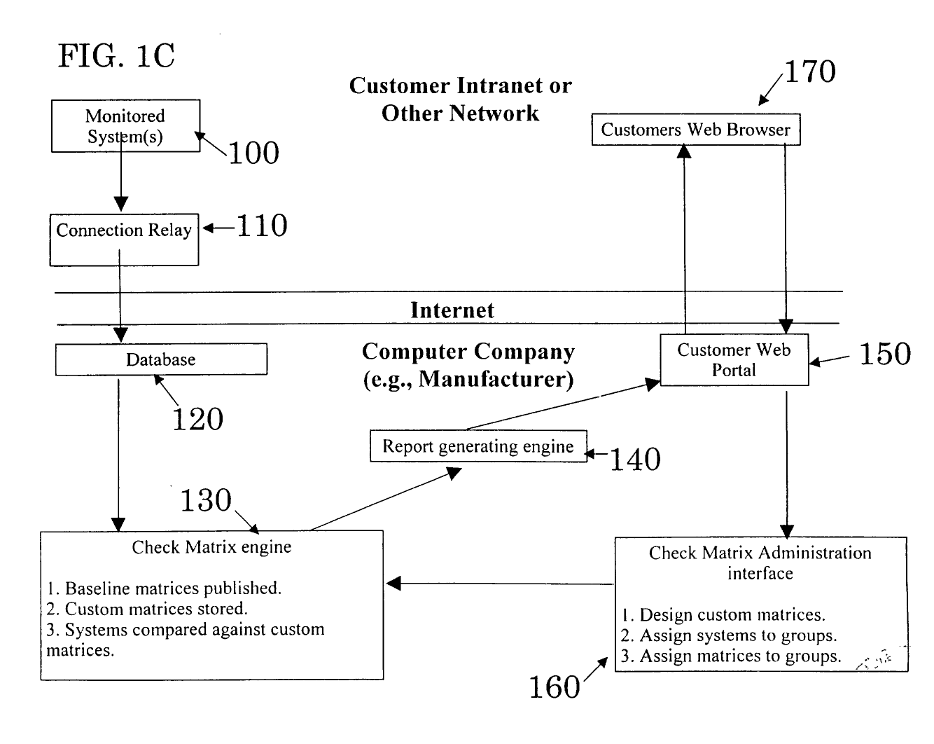

Illustrative embodiments of the present invention can be employed in a computer system having one or more computers. FIGS. 1A-1C show illustrative computer systems with which some embodiments of the present invention can be employed.

FIG. 1A is an illustrative schematic diagram showing a system 10 that can be accessed by multiple users 20 via a Web site or other computer interface at client computers or the like executing browser software or the like, which system 10 is adapted to monitor a plurality of servers 30 (e.g., which may for example be affiliated with different data centers or the like, such as centers A, B, C in illustrative embodiments). FIG. 1B is a schematic diagram that shows that the system 10 may include, for example, one or more server(s) connected via a computer network (e.g. such as the World Wide Web [Web], the Internet, a wide area network [WAN], an intranet, a virtual private network [VPN], any other network of computers, a combination of such networks, or the like) to at least one client user computer 21 (e.g., a personal computer [such as shown in the illustrative example], lap top computer, personal digital assistant or any other computer device or system) such that the at least one server(s) may provide information to the client computers via the network. As shown, at least one application computer can be provided in various embodiments of the invention to carry out one or more aspect of the invention. The application computer(s), client computers and server(s) can include any appropriate computers. Illustrative computers can include, e.g.: a central processing unit; memory (e.g., RAM, etc.); digital data storage (e.g., hard drives, etc.); input/output ports (e.g., parallel and/or serial ports, etc.); data entry devices (e.g., key boards, etc.); etc. The client computers may contain browser software for interacting with the server(s), such as, for example, using hypertext transfer protocol (HTTP) to make requests of the server(s) via the Internet or the like.

FIG. 1C shows an illustrative system architecture that can be employed in some illustrative preferred embodiments of the invention. As shown, a monitored system 100 (e.g., a server or the like and/or a plurality of such systems) can be monitored by accessing and delivering system performance data at 110 (e.g., using in one illustrative embodiment NETCONNECT by SUN MICROSYSTEMS which utilizes a secure Internet infrastructure to access and deliver system performance data to a customer's password-protected Web portal). This data is preferably stored in at least one database 120. Then, a utility 130 can be run to identify areas of potential future failure or poor performance (such as, e.g., ERAS by SUN MICROSYSTEMS in one illustrative embodiment of the invention). As shown, the utility 130 preferably publishes baseline matrices (e.g., including patch sets), stores custom matrices and compares systems against custom matrices.

As shown, the system preferably includes a report generating engine 140 that creates reports based on the utility 130 analyses. The system preferably includes a customer Web portal interface 150 or other user interface through which, for example, results can be presented to customers. As also shown, the user interface preferably includes an administrative interface 160 through which, for example, administrators may: 1) design custom matrices; 2) assign systems to groups or the like; and/or 3) assign matrices to groups or the like.

In this manner, in the illustrative embodiments, customers may be able to access a Web portal or the like using browser software 170 executing on client computers to perform tasks and the like according to the various embodiments of the invention.

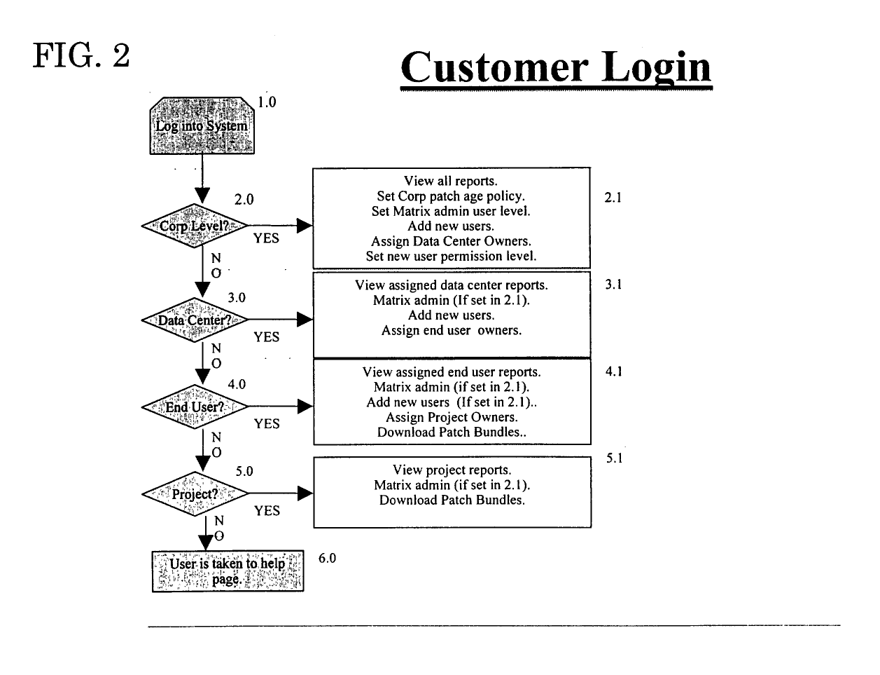

FIGS. 2-6 show system flow diagrams demonstrating some features and functionality that may be employed in some illustrative and non-limiting embodiments of the invention. In this regard, FIG. 2 shows illustrative functionality that may be available to a user or customer via a network portal interface, such as a Web site or the like. Various embodiments may employ one or more of these and/or other steps as understood based on the present disclosure. In the illustrative embodiments, in step 1.0, a customer may log into the system. Preferably, the user log-in is password protected, such as using an alphanumeric user name and/or an alphanumeric identification (ID) to limit use to authorized users and to enable the system to retrieve user-specific information. As illustrated, once a user has logged into the system, the user is preferably presented with one or more of the following options: corporate level (see step 2.0); data center level (see step 3.0); end user level (see step 4.0); and/or project level (see step 5.0). These options can be made available selectively based on user permissioning.

As also shown in FIG. 2, if the customer enters at the corporate level, the system preferably provides the customer with the ability to perform one or more, preferably all, of the following: view all reports;

set corporate patch age policy; set matrix administration user level; add new users; assign data center owners; and/or set new user permission level (see step 2.1).

As also shown in FIG. 2, if the customer enters at the data center level, the system preferably provides the customer with the ability to perform one or more, preferably all, of the following: view assigned data center reports; matrix administration (e.g., if set in 2.1); add new users; and/or assign end user owners (see step 3.1).

As also shown in FIG. 2, if the customer enters at the end user level, the system preferably provides the customer with the ability to perform one or more, preferably all, of the following: view assigned end user reports; matrix administration (if set in 2.1); add new users (if set in 2.1); assign project owners; download patch bundles (see step 4.1).

As also shown in FIG. 2, if the customer enters at the project level, the system preferably provides the customer with the ability to perform one or more, preferably all, of the following: view project reports; matrix administration (if set in 2.1); and/or download patch bundles.

If the user has questions or difficulties, rather than following the functional routes discussed above, the user may be taken to a help page as shown (see step 6.0).

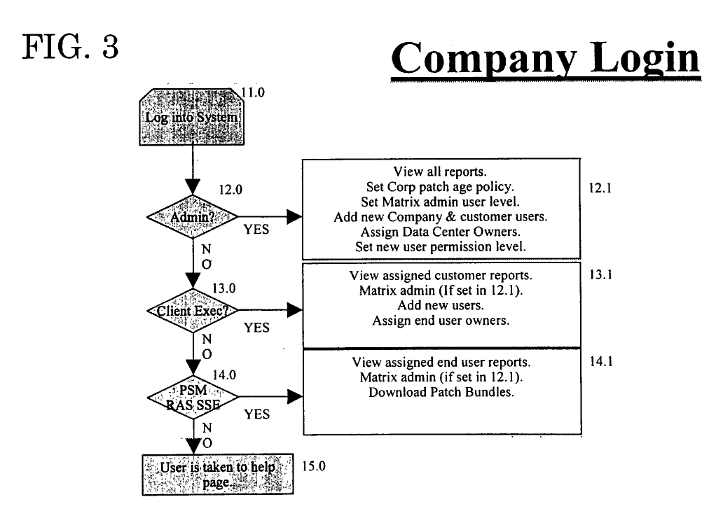

FIG. 3 shows illustrative steps and functionality that may be provided by the system company (e.g., the manufacturer, retailer, manager, provider or the like of servers or other systems) via a network portal interface, such as a Web site or the like. In preferred embodiments, the interface may use a secure encrypted protocol such as, e.g., Hypertext Transfer Protocol over Secure Socket Layer (HTTPS) or the like. In the illustrative embodiment, in step 11.0, a company user may log-in to the system (e.g., using an appropriate password and/or user ID or the like). As illustrated, once a company user has logged into the system, the company user is preferably presented with one or more of the following options: administration (see step 12.0); client executive (see step 13.0); customer support (see step 14.0). These options can be made available selectively based on user permissioning.

As also shown in FIG. 3, if the company user enters at administration in step 12.0, the system preferably provides the company user with the ability to perform one or more, preferably all, of the following: view all reports; set corporate patch age policy; set matrix administration user level; add new company and/or customer users; assign data center owners; and/or set new user permission levels (see step 12.1).

As also shown in FIG. 3, if the company user enters at client executive in step 13.0, the system preferably provides the company user with the ability to perform one or more, preferably all, of the following: view assigned customer reports; matrix administration (if set in 12.1); add new users; assign end user owners (see step 13.1).

As also shown in FIG. 3, if the company user enters at support in step 14.0, the system preferably provides the company user with the ability to perform one or more, preferably all, of the following: view assigned end user reports; matrix administration (if set in 12.1); and/or download patch bundles (see step 14.1). For instance, the support users may include, e.g., one or more of a Pre-emptive Service Manager (PSM), System Support Engineer (SSE), Reliability-Availability-Serviceability (RAS) engineers and/or other individuals.

If the company user has questions or difficulties, rather than following the functional routes discussed above, the user may be taken to a help page as shown (see step 15.0).

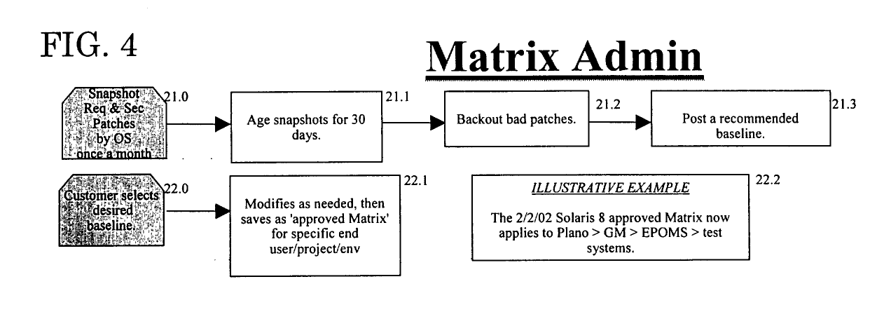

FIG. 4 shows illustrative steps and functionality that may be employed for matrix administration. First, in step 21.0, the system may be used to provide a snapshot of recommended and/or security patches by operating system (OS) on a periodic basis (e.g., once a month in one illustrative and non-limiting example). In step 21.1, snap shots may be aged for a predetermined period (such as, e.g., for 30 days in one illustrative and non-limiting example). In step 21.2, the system may be used to back out bad patches. In step 21.3, the system may be used to post a recommended baseline. In various embodiments, steps 21.0, 21.1, 21.2 and/or 21.3 may involve significant administrator input and/or may be substantially automated. Second, in step 22.0, the system may be used to enable a customer to select a desired baseline. In step 22.1, the system may be used to enable the customer to modify the desired baseline, as need, and then to save the same as an “approved matrix” which may be applied to one or more of, e.g., a specific end user, a specific project and/or a specific environment. In FIG. 4, element 22.2 shows one illustrative and non-limiting example of an approved baseline posted—i.e., in that example, an approved Feb. 2, 2002 matrix for a SOLARIS system is identified as applying across a certain data center (e.g., Plano), for a certain end user (e.g., GM), for a certain project (e.g., EPOMS), for a certain environment (e.g., test systems).

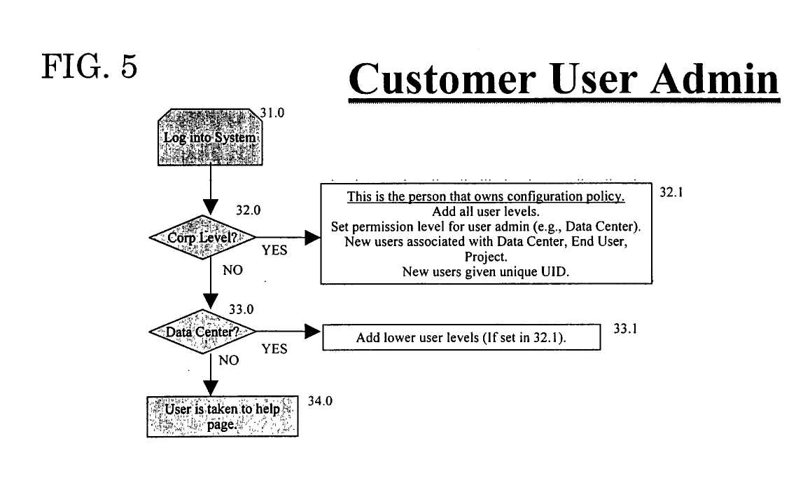

FIG. 5 shows illustrative steps and functionality that may be employed for customer user administration. In preferred embodiments, new users have unique user identifications (UIDs) generated. Preferably, new users are associated with one or more data center, one or more end user and/or one or more project. Among other things, this enables the system to present information to users based on user permissioning. Preferably, new user UIDs and/or passwords are sent to users via e-mail.

As shown, for customer user administration, an administrator first logs into the system at step 31.0. If the administrator is operating at the corporate level, then the administrator is presented with the option to administer the corporate level (see step 32.0) and perform the steps set forth in step 32.1. In that regard, the administrator (i.e., this would be, for example, the person[s] that would own the configuration policy) may perform one or more, preferably all of the following: add all user levels; set permission levels for user administration (e.g., data center); set new users associated with one or more of a data center, an end user and/or a project; and/or provide new users a unique user identification. In step 33.0, if the administrator is operating at the data center level, the administrator may be presented with the ability to add lower user levels (if the ability to do such was set in 32.1) (see step 33.1).

If the administrator user has questions or difficulties, rather than following the functional routes discussed above, the user may be taken to a help page as shown (see step 34.0).

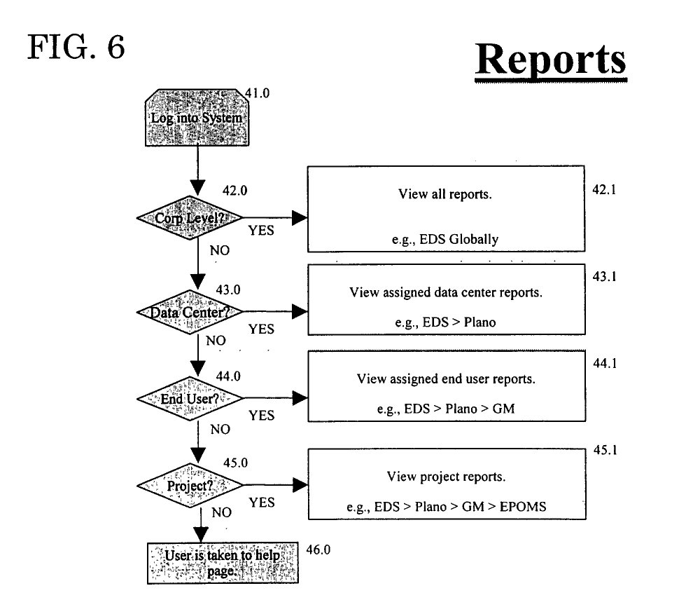

FIG. 6 shows illustrative steps and functionality that may be employed for viewing reports generated by the system. As shown, in step 41.0, a user logs onto the system. If the user is a corporate level user, the user is enabled to view all reports (see, e.g., steps 42.0 and 42.1). In one illustrative and non-limiting embodiment, this may include, e.g., the ability to view all EDS reports globally. If the user is a data center level user, the user is enabled to view all reports for that data center (see, e.g., steps 43.0 and 43.1). In one illustrative and non-limiting embodiment, this may include, e.g., the ability to view all EDS reports for a specific data center, such as, e.g., for a Plano data center. If the user is an end user level user, the user is enabled to view all reports for that end user (see, e.g., steps 44.0 and 44.1). In one illustrative and non-limiting embodiment, this may include, e.g., the ability to view all EDS reports for a specific end user within a particular data center, such as, e.g., for GM within a Plano data center. If the user is a project level user, the user is enabled to view all reports for one or more specific projects (see, e.g., steps 45.0 and 45.1). In one illustrative and non-limiting embodiment, this may include, e.g., the ability to view all EDS reports for one or more projects of a certain end user within a particular data center, such as, e.g., for EPOMS projects of GM within a Plano data center.

If the user has questions or difficulties, rather than following the functional routes discussed above, the user may be taken to a help page as shown (see step 46.0).

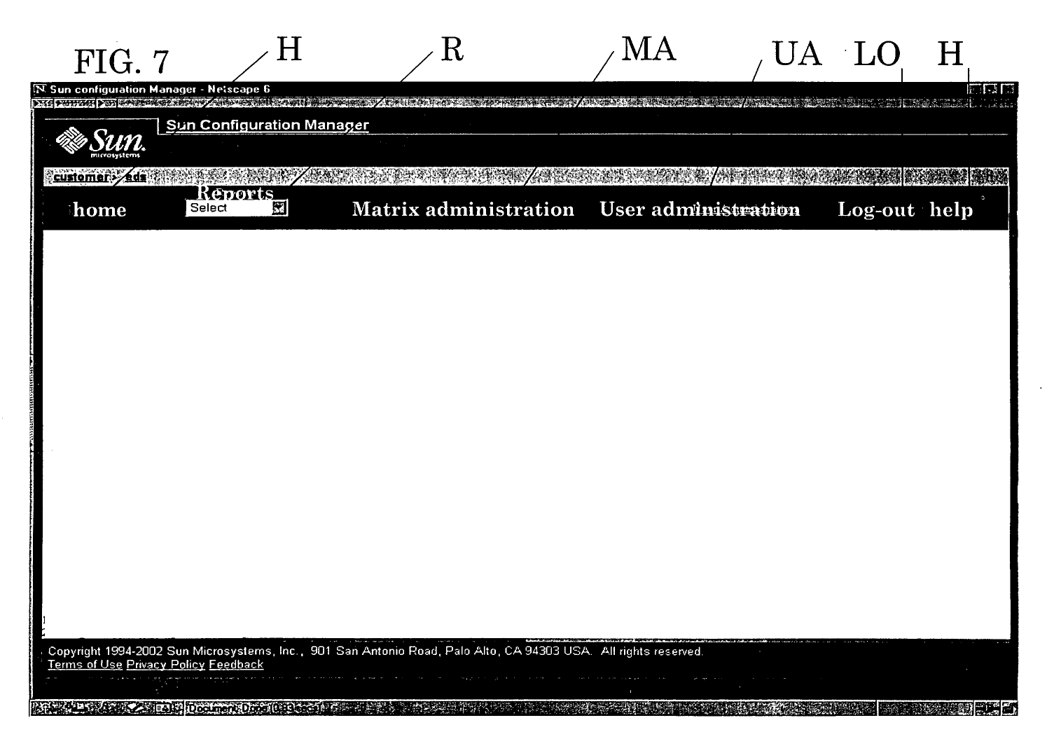

FIGS. 7-13 show some illustrative user interfaces that may be presented to users in some illustrative and non-limiting embodiments.

FIG. 7 shows, by way of example, an illustrative user interface that can be provided as, for example, a secure Web page. In this illustrative example, the Web page shown may be that of a highest level user (e.g., the owner of all data centers world wide) upon successful log-in. As shown, the Web page may include, for instance, a link H (e.g., hyperlink or other location direction means to present another Web page, URL or the like) may be provided to direct the user to a home page. In illustrative embodiments, a link R may be provided to direct the user to one or more available reports. In one illustrative and non-limiting embodiment, a drop-down menu can be provided so as to facilitate user ability to view and select desired reports. In other embodiments, any other known means of selection may be used. In illustrative embodiments, a link MA may be provided to direct the user to matrix administration functionality. In illustrative embodiments, a link UA may be provided to direct the user to user administration functionality. In illustrative embodiments, a link LO may be provided to enable users to log-out of the system. In illustrative embodiments, a link H may be provided to enable users to view help information and/or contact user support (e.g., on-line user support or the like).

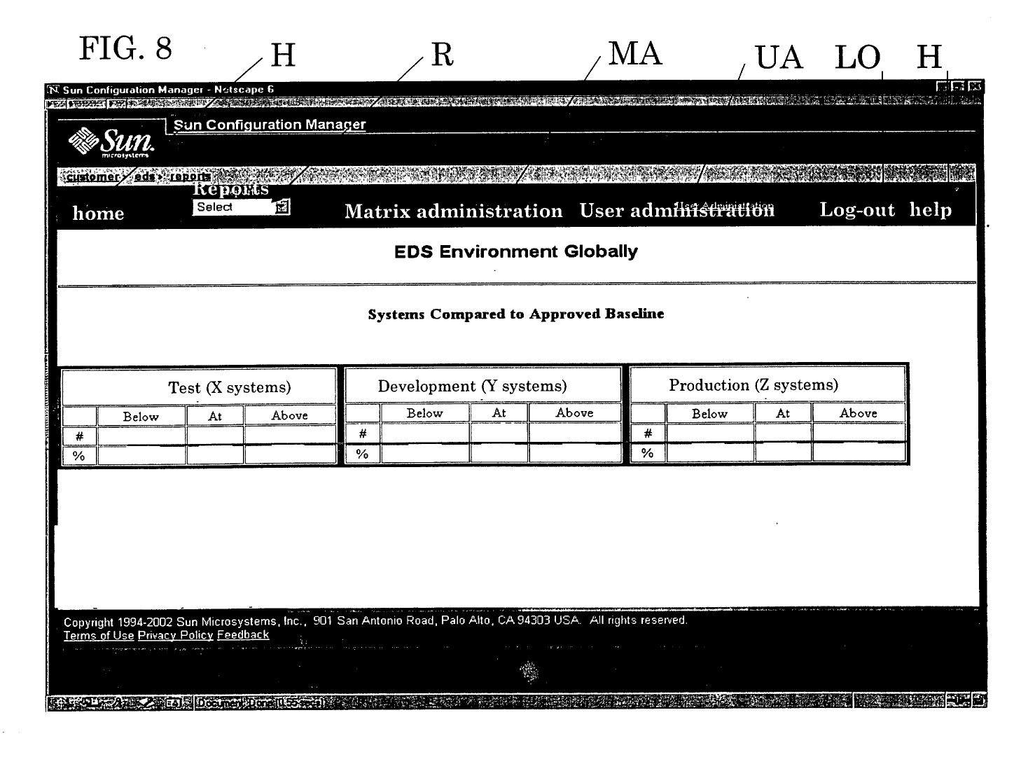

FIG. 8 shows, by way of example, an illustrative report that can be presented to the a user. In the illustrative example, the report is a global report (i.e., a report covering a wide-region, such as, for example, world-wide) showing systems compared to a particular approved baseline. In this illustrative embodiment, X test systems are compared, Y development systems are compared and Z production systems are compared. In this illustrative embodiment, the numbers of systems may be shown in actual numbers (e.g., #) and/or in percentages (e.g., %). It should be understood based on this disclosure that various other reports, modifications of these reports, etc., may be used in numerous other embodiments of the invention.

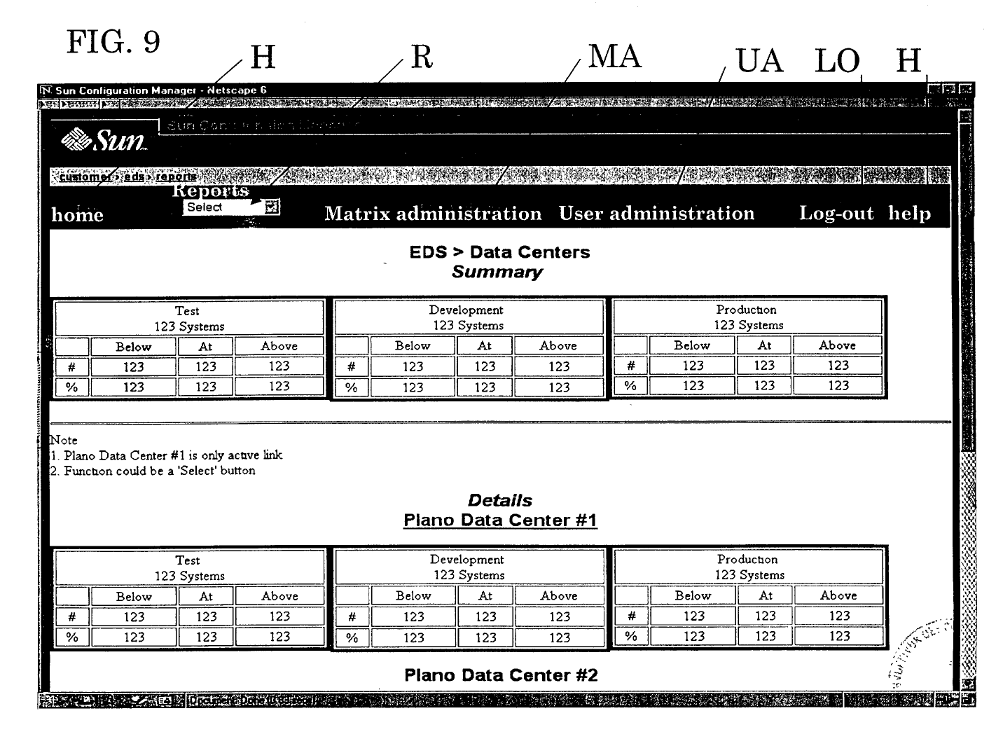

FIG. 9 shows an illustrative report similar to that shown in FIG. 8, but including specific information at a data center level (i.e., in the illustrative embodiment for a particular data center designated Plano Data Center #1. In the figures, the numerals 123 represent variables that may, as would be understood based on this disclosure, vary for each occurrence on the figures; that is, the variables 123 shown would not necessarily have the same numerical values. In some embodiments, additional reports may be viewed by clicking on the “select” drop down menu and/or by clicking on an embedded hyperlink within the words Plano Data Center #1. Similarly, to view reports for Plano Data Center #2, a user may, for example, click on an embedded hyperlink within the words Plano Data Center #2 and then click on “select” and/or again click on the words Plano Data Center #2 in some illustrative and non-limiting embodiments.

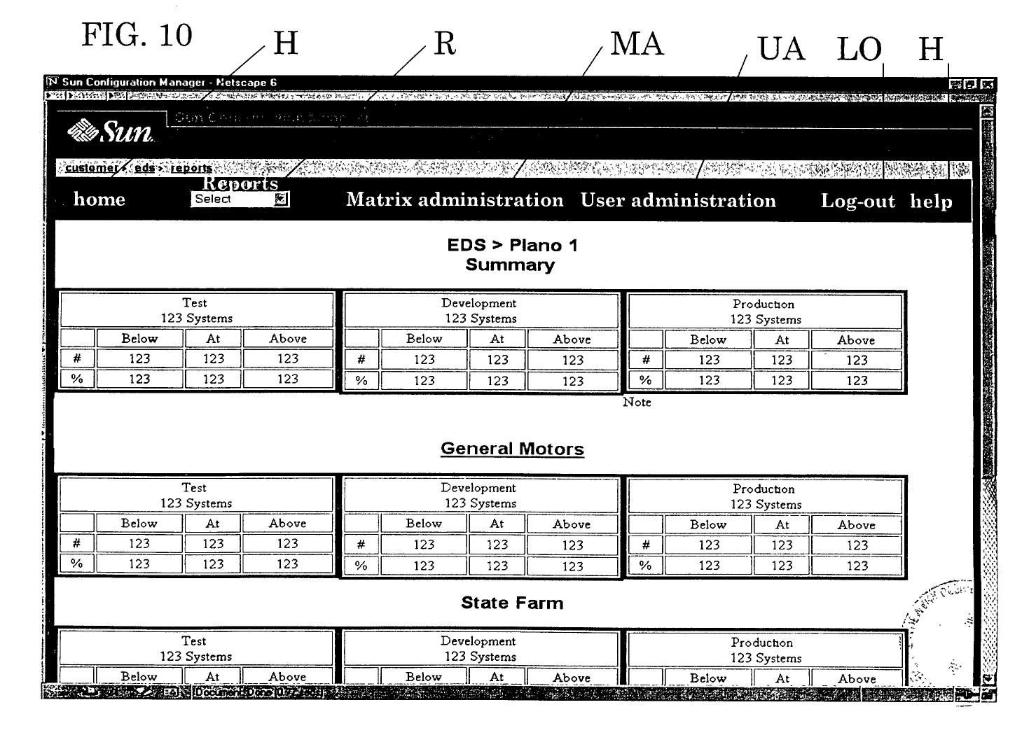

FIG. 10 shows another illustrative report similar to that shown above in FIG. 9, but including specific information at an end user level (i.e., in the illustrative embodiment for a particular end user within the Plano Data Center #1—as illustrated here, for GENERAL MOTORS as merely one example). In the illustrative example shown in FIG. 10, the link entitled GENERAL MOTORS is an active link and to view additional reports related to this end user, a user may either click select in the drop down menu and/or click on the words GENERAL MOTORS or the like in some illustrative and non-limiting embodiments. Once again, in the figures, the numerals 123 represent variables that may vary for each occurrence.

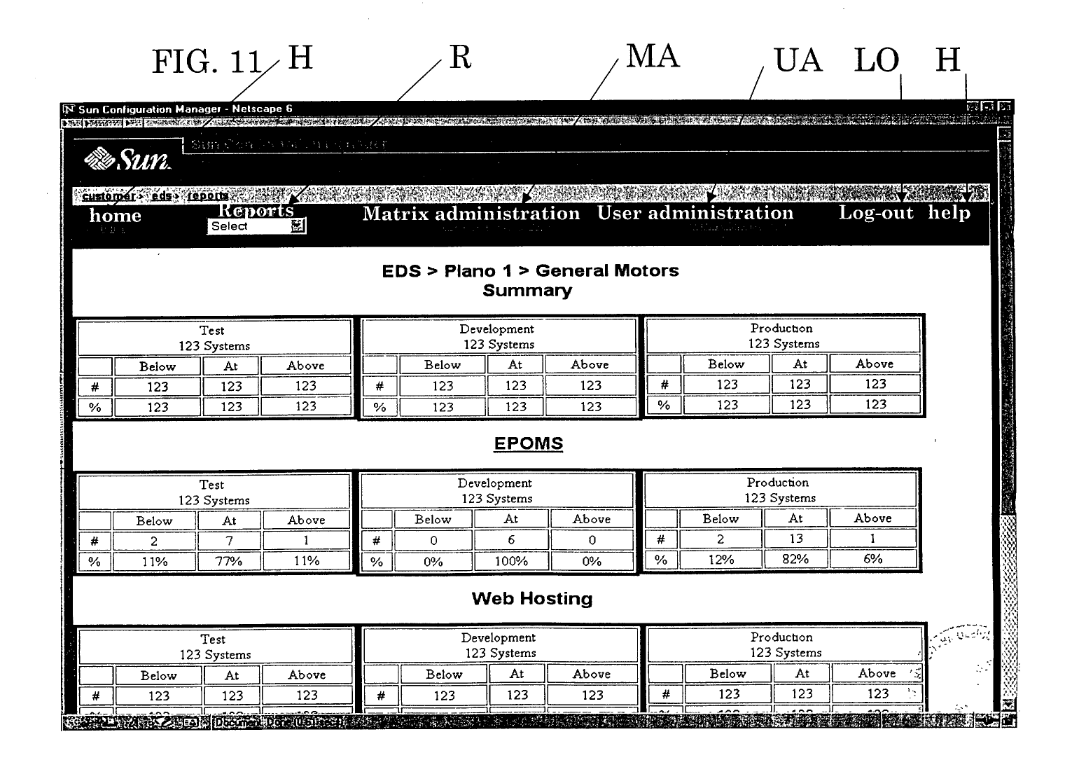

FIG. 11 shows another illustrative report similar to that shown above in FIG. 10, but including specific information at the project level (i.e., in the illustrative embodiment, for a particular project of the GENERAL MOTORS end user within the Plano Data Center #1). In the illustrative example shown in FIG. 11, the link entitled EPOMS is an active link and to view additional reports related to this project, a user may either click select in the drop down menu and/or click on the words EPOMS or the like in some illustrative and non-limiting embodiments. Once again, in the figures, the numerals 123 represent variables that may vary for each occurrence.

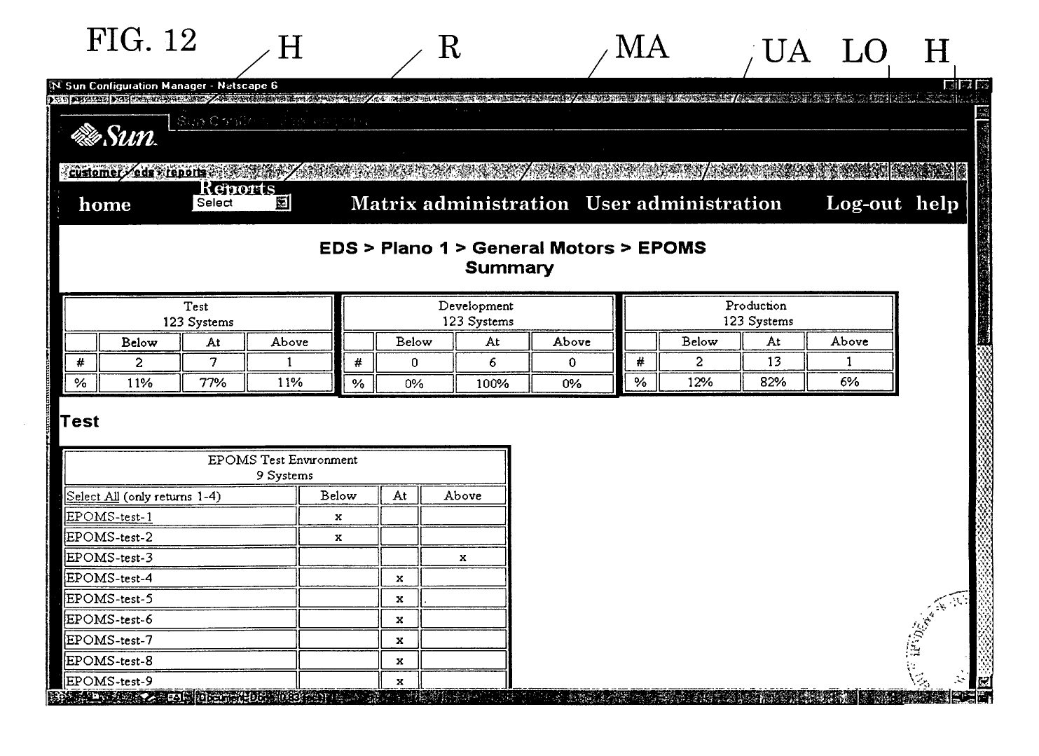

FIG. 12 shows another illustrative report similar to that shown above in FIG. 11, but including specific information at the system level (i.e., in the illustrative embodiment, for particular systems within the EPOMS project of the GENERAL MOTORS end user within the Plano Data Center #1). In the illustrative example shown in FIG. 12, a user has selected specific system information related to Test 123 System, such as by clicking on an appropriate selection under select in the drop down menu and/or clicking on the words Test 123 System in some illustrative and non-limiting embodiments. In the illustrative and non-limiting embodiment, seven systems are shown as at a predetermined baseline, two are shown as below, and one is shown as above. Specifically, systems 4-9 are shown at the baseline, systems 1-2 are shown as below the baseline, and system 3 is shown as above the baseline. Once again, these reports are merely illustrative examples, and numerous other reporting styles, features, and methods may be used in various other embodiments.

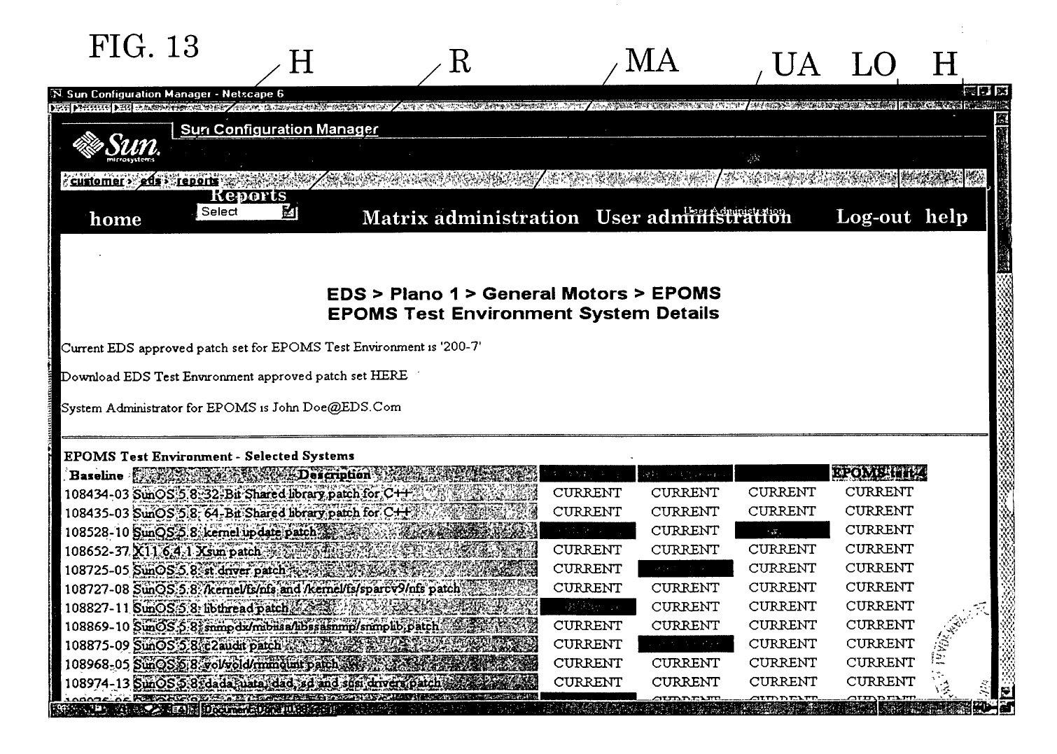

FIG. 13 shows another illustrative report similar to that shown above in FIG. 12, but including test environment system details. In the illustrative example shown in FIG. 12, a user has selected specific system information related to Test 123 System details, such as by clicking on an appropriate selection under select in the drop down menu in some illustrative and non-limiting embodiments. In the illustrative and non-limiting embodiment, the display may present some or all of the following:

Information related to approved patches (such as, e.g., shown at the language “Current EDS approved patch set for EPOMS test environment is ‘200-7’”);

Means to download approved patches (such as, e.g., shown at the language “Download EDS approved patch set HERE” which can include embedded code to initiate downloading or to direct the user to another page to effect downloading or the like);

Information for contacting the system administrator (such as, e.g., shown at the language “System Administrator for EPOMS is John.Doe@EDS.com”);

Information related to approved baselines, descriptions, and system configurations (such as, e.g., in the illustrative and non-limiting embodiment shown including a chart of baseline patches with descriptions related thereto and identification of the statuses of the various systems vis-à-vis such baseline patches, such as, e.g., identifying if such are “CURRENT” or including numbers to show such to be below or above the same). For example, in the illustrative embodiment, baseline patch 108528-10 would be above that in test 1, but below that in test 3.

In the preferred embodiments, users will be enabled to view reports based on user permissioning. For instance, users may be permissioned so as to be limited to one or more level as discussed above. In preferred embodiments, there will be multiple levels of customer access to the configuration management system. In illustrative and non-limiting preferred embodiments, there will be four levels of access for corporate level, data center level, end user level and project level. In illustrative embodiments, the software manufacture or the like company will preferably publish a periodic (e.g., monthly or the like) recommended patch matrix.

In illustrative embodiments, a utility will be employed to gather information about the customer's environment (such as, e.g., in some illustrative and non-limiting embodiments using the EXPLORER utility by SUN MICROSYSTEMS).

In illustrative and non-limiting embodiments, a customer can select a specific patch matrix, modify it for their needs and then apply it to a specific system as a baseline for the rest of the process. As merely one illustrative and non-limiting example, an ELECTRONIC DATA SYSTEMS CORPORATION (“EDS”) data center manager, for example, could select, e.g., one patch set to use as a baseline for all of an entity's Web hosting systems that are now in, e.g., their “test” environment.

In illustrative and non-limiting embodiments, a system's state can be made known to permissioned users by viewing live reports related thereto on-line.

In illustrative and non-limiting embodiments, the reports could be used to view various environments, such as in merely some illustrative examples: global environments; systems associated with one data center; systems associated with one end user; systems associated with one environment (such as, e.g., test, development, production and/or the like); or one system.

A system administrator will preferably be able to see how their system(s) compare(s) to corporate standards.

A system administrator will preferably be able to use an on-line interface (e.g., to click or hit one or a few buttons) such that the interface downloads patches that are specific for that system, based on an approved matrix.

In illustrative and non-limiting embodiments, data centers may include: periodically run, preferably bi-weekly, cron jobs (a cron job or script can include, e.g., a list of one or more commands to a computer operating system or application server that are to be executed at a specified time); outputs that are submitted to the manufacturer or the like company via e-mail or the like; and/or a patch standard policy developed with a manufacturer or the like company account team.

In further illustrative embodiments, the system may be configured to perform one or more of the following:

Recommended and/or security patch audits of environments, such as, e.g., entire data centers.

Firmware checks.

Firmware revision level checks (e.g., disks, boards and/or the like).

Customised configuration checks.

Accept Requests for Enhancements (“RFEs”) to expand abilities.

Reports on down and/or revived systems for customers.

Customer specific checks (e.g., savecore enabled, console logging, root login disabled, license expiration dates, etc.).

3rd party patches (such as, e.g., that of VOS [including Veritas Software, Oracle and Sun Microsystems, working together as VOS], JAYCOR or the like).

Alerts of patches available for auto-download by customer.

In some embodiments, one or more of the following advantages may be achieved, but these are not necessarily required in various embodiments.

Advantageously keeping customer systems current.

Increasing customer satisfaction.

Reducing administration efforts.

Reducing the total cost of ownership.

Enabling management of standard configurations over a wide area or region, such as globally.

Increasing availability.

Driving customer systems to stay current with baseline configurations.

Enabling reports on customer system status over a wide area or region, such as globally.

Reducing service calls for support services (e.g., on-line support and more) and field personnel.

### ILLUSTRATIVE EXAMPLES

In some illustrative and non-limiting examples, a system can be employed utilizing some of the following technologies:

EXPLORER

EXPLORER is a data collection utility used to analyze SUN systems such as SUN SOLARIS. The utility collects information covering substantially every known variable in a system, then places them into a file for transfer back to SUN. For instance, a command/file list may include:

“Cluster” which collects cluster information. The cluster script uses many loops to collect data. It attempts to collect data for ORACLE, SYBASE, INFORMIX, SAP, NFS and HA-HTTPD. For each database, it also attempts to collect data for each instance.

“CST” which collects CST information.

“Disks” which collects generic disk information. The disks script uses loops to collect data for each disk in /dev/rdsk/ and enclosures in /dev/es/. It will also collect data for each file system in df-Ifufs.

“EMC” which collects EMC powerpath information.

“ETC” which collects /etc configuration files.

“FCAL” which collects disk information on internal FCAl drives.

“Firelink” which collects SUN Firelink Interconnect information.

“Fru” which collects FRUid information.

“Init” which collects init.d scripts.

“Lic” which collects license information.

“Lp” which collects printer information.

“Nbu” which collects Net Backup information.

“Ndd” which collects device driver information. The ndd script attempts to collect driver information for 4 services (IP, TCP, UDP and ICMP). It also collects data for up to 16 instances of 10 cards (like HME or QFE). For each service or card instance, the script will collect data for all parameters of that driver.

“Netinfo” which collects generic network information.

“Patch” which collects patch information.

“Photon” which collects StorEdge A5X00 information. The photon script will collect data for each StorEdge A5X00 found.

“Pkg” which collects package information.

“Sbu” which collects Solstice Backup information.

“Scextended” which collects Serengeti System Controller information. This is an interactive script. Data will be collected for each System Controller provided by the user.

“Sds” which collects Solstice DiskSuite information.

“Sonoma” which collects StorEdge A3X00 information. Additional data for each LUN will be collected.

“Ssa” which collects SPARCstorage Array information. Data will be collected for each SPARCstorage Array found.

“Ssp” which collects E10k System Service Processor information. Data will be collected for all system and I/O boards. Control Board data is also collected.

“Stortools” which collects STORtools 3.x information.

“Sunray” which collects Sunray server information.

“Sysconfig” which collects system configuration information. Values set in /etc/system will be checked and data will be collected for all core files found and for each class dispatch table.

“T3” which collects StorEdge T3 information. Data will be collected for each StorEdge T3 LUN found.

“T3 extended” which collects extended StorEdge T3 information. This is an interactive script. Data will be collected for each StoreEdge T3 provided by the user.

“U4ft” which collects Sheffield information. All eeprom data will be collected.

“Var” which collects log and config information in /var. All crontab files will be collected.

“Vtsst” which collects STORtools 4.x information.

“Vxfs” which collects Veritas Filesystem information. Data will be collected for each file system in df-Ifvxfs.

“Vxvm” which collects Veritas Volume Manager information. Data will be collected for each diskgroup found.

In preferred embodiments, one or more, preferably all, of the following customer information will be added within a customer information file:

Customer (e.g.: EDS or the like)

Data Center (e.g.: Plano or the like)

End User (e.g.: GENERAL MOTORS or the like)

Department, Division and/or Project (e.g.: EPOMS)

Environment (e.g.: Test, Develop and/or Production)

ERAS

ERAS is a SUN MICROSYSTEMS tool that can be run to identify areas of potential future failure or poor performance. The utility can run a product matrix class check (e.g., check matrix utility) for elements (such as, e.g., dynamic data) that can be checked that represent and correspond to product patches and the like.

In preferred embodiments, one or more, preferably all of the following capabilities will be provided.

Check matrix utility.

Preferably, periodic (e.g., monthly) patch sets will be created.

Preferably, patches will be aged for time periods (e.g., preferably 30 days).

Preferably, bad patches will be backed out.

Publish baseline matrix (e.g., periodically, such as monthly).

Allow custom matrices to be saved by customers.

Provide downloadable custom patch sets for customers.

NETCONNECT

NET CONNECT is a Web-based, self-monitoring tool that enables SUN MICROSYSTEMS customers to take advantage of asset reporting and basic monitoring, to assist in the management of their SUN server and storage systems. SUN customers can realize higher availability through NETCONNECT's early problem detection and system performance reporting. NETCONNECT utilizes a secure Internet infrastructure to access and deliver system performance data to a customer's password-protected Web portal. NETCONNECT offers SUN customers several valuable features. Asset Survey is a detailed inventory tool that can keep users up-to-date on the resources that reside in their SUN systems. Server self-monitoring is a monitoring tool to help manage the availability of non-mission critical machines. Powerful, scalable, customizable and robust, the NETCONNECT storage self-monitoring agent is designed to manage potential SUN Storage events before they become critical. NETCONNECT is designed for anyone who wants to monitor and manage SUN IT environments. NETCONNECT can be downloaded via the Web. It requires only NETCONNECT software and is simple for SUN SOLARIS™ system administrators to install and use.

The foregoing illustrative examples are for illustrative purposes and various other embodiments can be made within the broad scope of the invention as described herein.

Broad Scope of the Invention:

While illustrative embodiments of the invention have been described herein, it will be appreciated that the present invention is not limited to the various embodiments described herein, but includes any and all embodiments having modifications, omissions, combinations (e.g., of aspects across various embodiments), adaptations and/or alterations as would be appreciated by those in the art based on the present disclosure. The appended claims are to be interpreted broadly based the language employed in the claims and not improperly limited to illustrative examples described in the present specification or in the prosecution of the application. As merely one example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts are not recited in support of that function.

What is claimed is:

1. A system for managing configuration of a plurality of computer-systems, comprising:
a) means for selecting an approved baseline configuration matrix to be applied to said plurality of computer-systems;
b) means for retrieving computer-system configuration information from said plurality of computer-systems;
c) means for comparing retrieved computer-system configuration information for said plurality of computer-systems to said approved baseline configuration matrix.

2. The system of claim 1, further including means for generating reports regarding the configuration of a plurality of said plurality of computer-systems.

3. The system of claim 2, further including a customer user administration interface means for at least one owner of configuration policy to add users and set user permissioning levels such that users may view said reports selectively based on user permissioning.

4. The system of claim 2, wherein said reports include reports regarding the configuration of a plurality of systems within a plurality of data centers.

5. The system of claim 4, further including a customer user administration interface means for at least one owner of configuration policy to add users and set user permissioning levels such that users may view said reports selectively based on user permissioning.

6. The system of claim 2, wherein said reports include reports regarding the configuration of a plurality of systems within a specific data center.

7. The system of claim 6, further including a customer user administration interface means for at least one owner of configuration policy to add users and set user permissioning levels such that users may view said reports selectively based on user permissioning.

8. The system of claim 2, wherein said reports include reports regarding the configuration of a plurality of systems of an end user.

9. The system of claim 8, further including a customer user administration interface means for at least one owner of configuration policy to add users and set user permissioning levels such that users may view said reports selectively based on user permissioning.

10. The system of claim 2, wherein said reports include reports regarding the configuration of a plurality of systems of a project.

11. The system of claim 10, further including a customer user administration interface means for at least one owner of configuration policy to add users and set user permissioning levels such that users may view said reports selectively based on user permissioning.

12. The system of claim 2, wherein said reports include reports regarding the configuration of a plurality of systems within a particular environment.

13. The system of claim 1, further including a matrix administration interface means for users to establish custom matrices.

14. The system of claim 8, wherein said matrix administration interface means includes means for assigning systems to groups.

15. The system of claim 9, wherein said matrix administration interface means includes means for assigning matrices to said groups.

16. The system of claim 1, further including a customer user administration interface means for at least one owner of configuration policy to add users and set user permissioning levels.

17. A method for managing configuration of a plurality of computer-systems, comprising:
a) selecting an approved baseline configuration matrix to be applied to the plurality of computer-systems;
b) retrieving computer-system configuration information from the plurality of computer-systems;
c) comparing retrieved computer-system configuration information for the plurality of computer-systems to said approved baseline configuration matrix.

18. The method of claim 17, further including generating reports regarding the configuration of a plurality of the plurality of computer-systems.

19. The method of claim 18, further including having at least one owner of configuration policy add users and set user permissioning levels such that users may view said reports selectively based on user permissioning.

20. The method of claim 18, further including having said reports include reports regarding the configuration of a plurality of systems within a plurality of data centers.

21. The method of claim 20, further including having at least one owner of configuration policy add users and set user permissioning levels such that users may view said reports selectively based on user permissioning.

22. The method of claim 18, further including having said reports include reports regarding the configuration of a plurality of systems within a specific data center.

23. The method of claim 22, further including having at least one owner of configuration policy add users and set user permissioning levels such that users may view said reports selectively based on user permissioning.

24. The method of claim 18, further including having said reports include reports regarding the configuration of a plurality of systems of an end user.

25. The method of claim 24, further including having at least one owner of configuration policy add users and set user permissioning levels such that users may view said reports selectively based on user permissioning.

26. The method of claim 18, further including having said reports include reports regarding the configuration of a plurality of systems of a project.

27. The method of claim 26, further including having at least one owner of configuration policy add users and set user permissioning levels such that users may view said reports selectively based on user permissioning.

28. The method of claim 17, further including using a matrix administration interface means to establish custom matrices.

29. The method of claim 28, further including assigning systems to groups using said matrix administration interface.

30. The method of claim 28, further including assigning matrices to said groups with said matrix administration interface.

31. The method of claim 17, further including having at least one owner of configuration policy add users and set user permissioning levels via a customer user administration interface.

32. A process for making configuration report products for managing configuration of a plurality of computer-systems, comprising:
a) selecting an approved baseline configuration matrix to be applied to the plurality of computer-systems;
b) retrieving computer-system configuration information from the plurality of computer-systems;
c) comparing retrieved computer-system configuration information for the plurality of computer-systems to said approved baseline configuration matrix;
d) generating reports regarding the configuration of a plurality of the plurality of computer-systems.

33. The process of claim 32, further including having at least one owner of configuration policy add users and set user permissioning levels such that users may view said reports selectively based on user permissioning.

34. The process of claim 32, further including having said reports include reports regarding the configuration of a plurality of systems within a plurality of data centers.

35. The process of claim 32, further including having said reports include reports regarding the configuration of a plurality of systems within a specific data center.

36. A system for the global management of the configuration of a plurality of computer-systems, comprising:
a) a computer-system configuration monitoring utility that monitors the plurality of computer-systems;
b) a database for storing computer-system configuration data received by the computer-system configuration monitoring utility;
c) a check matrix engine that analyses the stored computer-system configuration data;
d) a report generating engine that generates configuration reports pertaining to a plurality of the plurality of computer-systems.

37. The system of claim 36, further including a check matrix administration interface means for selecting custom matrices, assigning computer-systems to groups and assigning matrices to groups.

38. The system of claim 36, wherein said computer-systems include a plurality of server computers.

39. The system of claim 36, wherein said baseline configuration matrix includes a patch set matrix.
